(19) United States
(12) Patent Application Publication
(10) Pub. No.: US 2013/0049353 A1
(43) Pub. Date: Feb. 28, 2013

(54) BREAKAWAY HOSE COUPLING

(71) Applicant: Ajit Ghandi, Vitoria (CA)

(72) Inventor: Ajit Ghandi, Vitoria (CA)

(21) Appl. No.: 13/640,618

(22) PCT Filed: May 19, 2010
(86) PCT No.: PCT/CA2010/000741

§ 371 Date: Oct. 11, 2012

(51) Int. Cl. F16L 37/244

(52) U.S. Cl. 285/81

(57) ABSTRACT

The invention is a breakaway coupling for use in hoses carrying a high pressure fluid in the form of a gas. The coupling comprises four primary parts. A first part is attached to a first hose and a second part is attached to a second hose. The first part includes a threaded portion that couples with a threaded nut in a third body by an inserting and twisting movement. Axial forces generated by fluid flowing through the coupling must generate sufficient pressures to overcome the torsion forces holding the first and third bodies together. The third body is held within a fourth body housing and is permitted movement in a clockwise direction but prevented from movement in a counter-clockwise direction by a sprag clutch between the third body and the fourth body. The fourth body is attached to the second body. The invention includes means to create a lateral movement of fluid within the coupling to minimize axial backpressure forces that encourage decoupling.

### TECHNICAL FIELD

This invention relates to breakaway couplings for installation in a hose carrying high pressure fluids and specifically a gaseous fluid.

### BACKGROUND ART

Existing coupling designs employ restraining devices that are spring loaded or some other physical restraints that try to keep the coupling intact till a certain force is applied axially. Current couplings have a large variance in the force required for separation since the pressure within the hose exerts an axial force against the restraining forces maintaining the coupling. Hence as the pressure within the hose increases or decreases the force required to separate the coupling also varies. Therefore there is a need for a new design that uses a unique technique for a breakaway coupling in high pressure applications so that the variance in forces caused by internal fluid pressures is minimized.

### TECHNICAL PROBLEM

In one embodiment of the invention there is provided a breakaway coupling for connecting a first hose member to a second hose member carrying a fluid. A first body is attached by first attachment means to a first hose end and a second body is attached by second attachment means to a second hose end.

The first body comprises an attachment portion for attachment to the first hose and a threaded portion for twist insertion into a threaded nut on a third body to form a strong torsional coupling. The third body is housed within a fourth body and the fourth body is attached to the second body. The third body is permitted clock-wise rotation within the fourth body but is prevented from rotating counter-clockwise. The fourth body is permitted rotational motion with respect to the second body.

The first body has a stem portion depending from the threaded coupling portion. The stern portion extends into a second body cavity in a sealing relationship.

In still another embodiment of the invention the first body threaded portion and the threaded third body are held together by a torsional force having a predetermined magnitude so the tight torsional coupling decouples when an axial force having a magnitude greater than the torsional force is exerted between the first body and the third body.

The first, second and fourth bodies are cylindrical and have the same outer diameter.

In another embodiment of the invention the second body comprises a cylinder having a flat bottom surface. The hose attachment means is formed therein. There is a flat top surface and a bore extending into the second body from the flat top surface. Within the second body is a internal pressure dissipation means so that axial forces do not build up within the second body that could weaken the torsional forces holding the threaded portion of the first body to the treaded nut.

In one embodiment of the invention the fourth body comprises a cylinder having a flat top surface having a top aperture and a flat bottom surface having a bottom aperture.

A flanged connecting member connects the fourth member to the second member and permits rotation of the fourth body with respect to the second body.

A dust ring member is disposed between the second body and the fourth body.

The third body is disposed within the fourth body and permitted clock-wise rotation only due to a sprag clutch arrangement.

A second dust ring member is disposed between the third body within the fourth body.

### TECHNICAL SOLUTION

It is an object of the present invention to provide an improved breakaway coupling.

It is a further objective of the present invention to provide a breakaway coupling that is capable of dissipating axial forces causes by internal fluid pressures within the coupling.

One advantage of the present invention is that it uses a threaded coupling and torsional forces to hold the coupling together.

### ADVANTAGEOUS EFFECTS

### Description Of Drawings

FIG. 1 is a rear biased perspective exploded view of one embodiment of the invention.

FIG. 2 is a front biased perspective exploded view of one embodiment of the invention.

FIG. 3A-D are respectively side view, perspective view, end view and cross-section view of the second body.

FIG. 4A-D are respectively side view, perspective view, end view and cross-sectional view of the fourth body.

FIG. 5A-E are respectively, side view, bottom perspective view, front view, second side view, front view and cross-sectional side view of the flanged connecting member.

FIG. 6A-D are respectively, side view, perspective view, end view and cross-sectional view of the threaded nut portion of the third body.

FIG. 7A-D are respectively, side view, perspective view, top end view and cross-sectional view of the sealing plate.

FIG. 8A-D are respectively side view, perspective view, top end view and cross-sectional side view of the first body.

FIG. 9A-C are respectively side view, perspective view and end view of the spring.

FIG. 10 is an assembled view of the invention in cross-section.

FIG. 11 is a side view of the assembled invention.

### BEST MODE

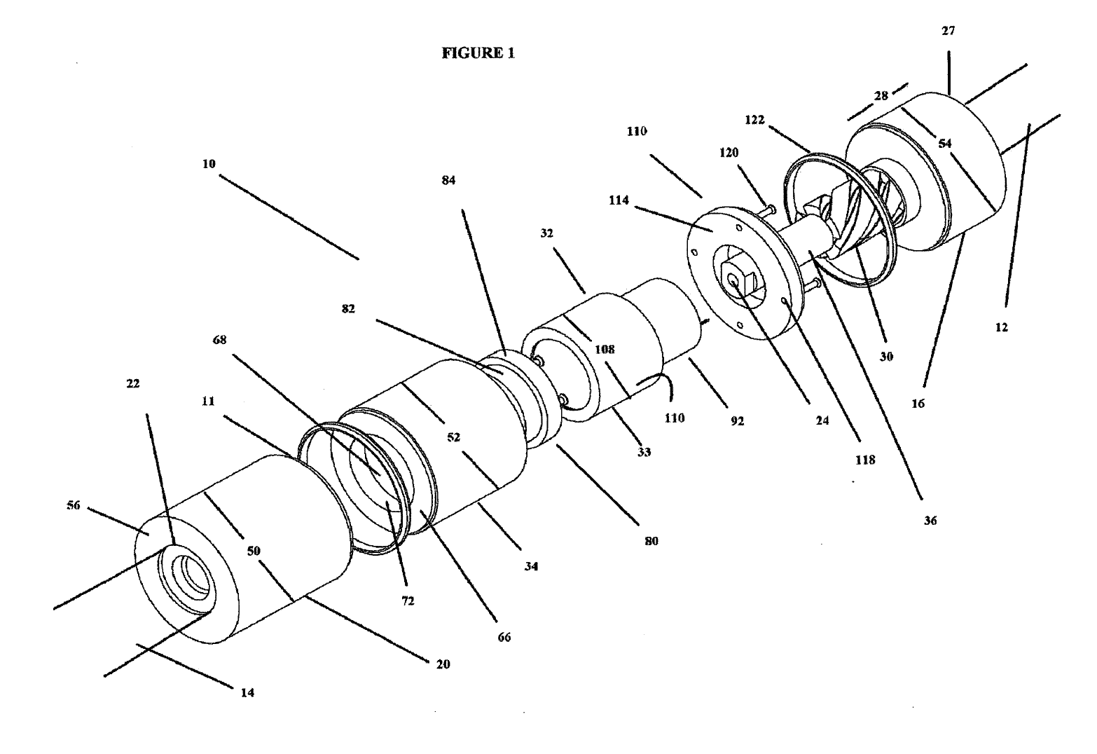

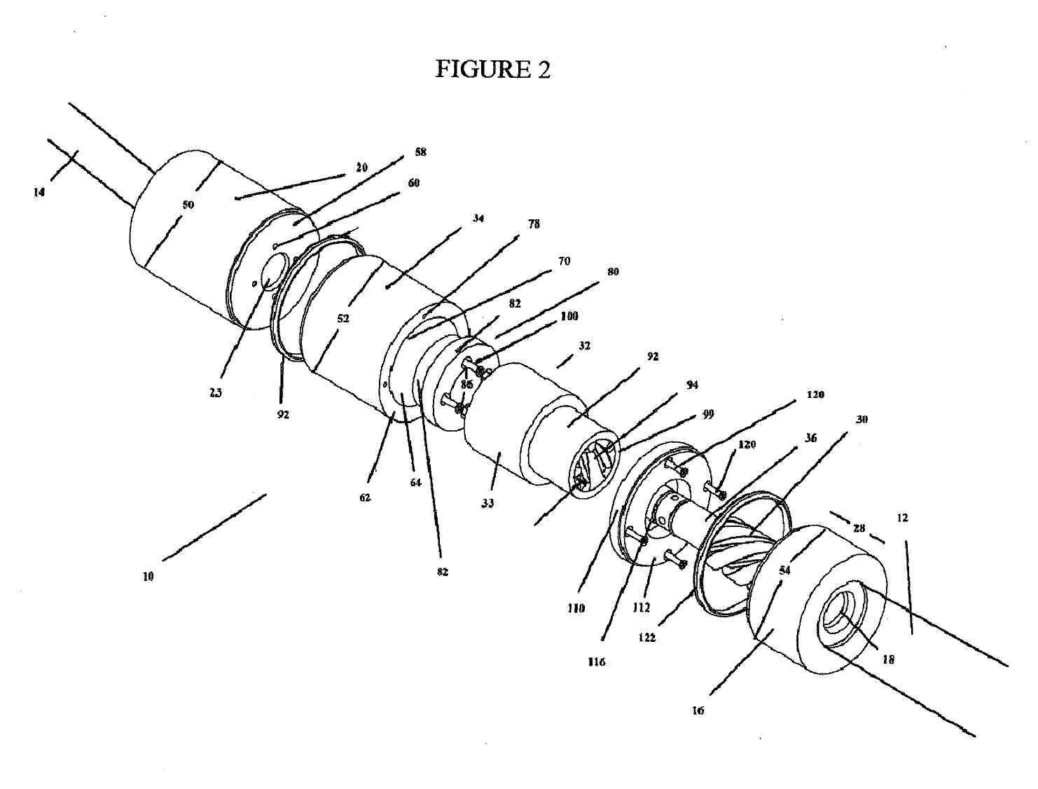

Referring to FIGS. 1 and 2 there is illustrated one embodiment of the invention 10 in front and rear exploded perspective views respectively. The invention 10 is a breakaway coupling for installation in a hose carrying a high pressure fluid such as natural gas or hydrogen gas. The anticipated fluid pressures ranged around 3600 psi. The preferred embodiment is constructed of stainless steel.

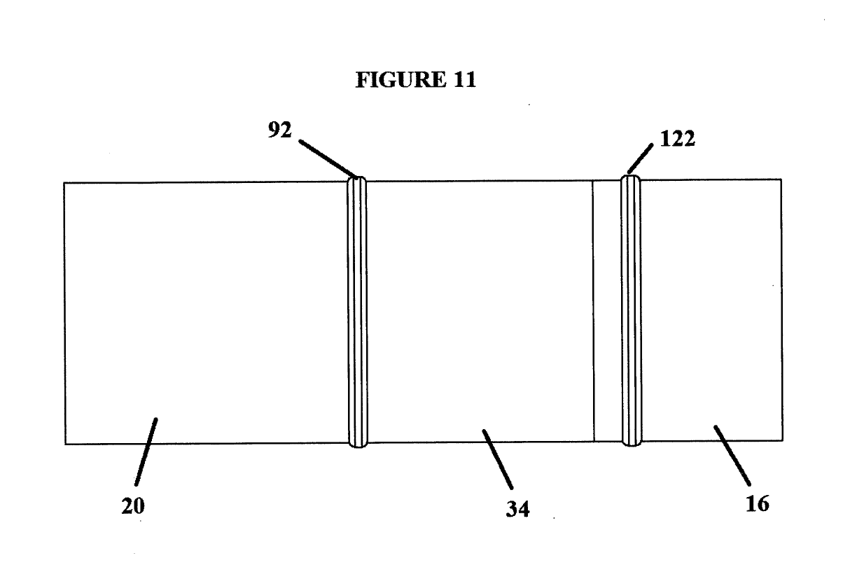

Breakaway coupling 10 connects a first hose member 12 to a second hose member 14. Breakaway coupling 10 comprises a first body 16 attached by first attachment means 18 to the first hose member 12 and a second body 20 attached by second attachment means 22 to the second hose member 14. Between the first 16 and second 20 is a fourth body 34 which houses coupling means as more fully explained below. The first body diameter 54, second body diameter 50 and fourth body diameter 52 are equal so that the assembled coupling has the profile shown in FIG. 11. Between the second body 20 and the fourth body 34 is a first dust ring 92 and between the fourth body and the first body is a second dust ring 122.

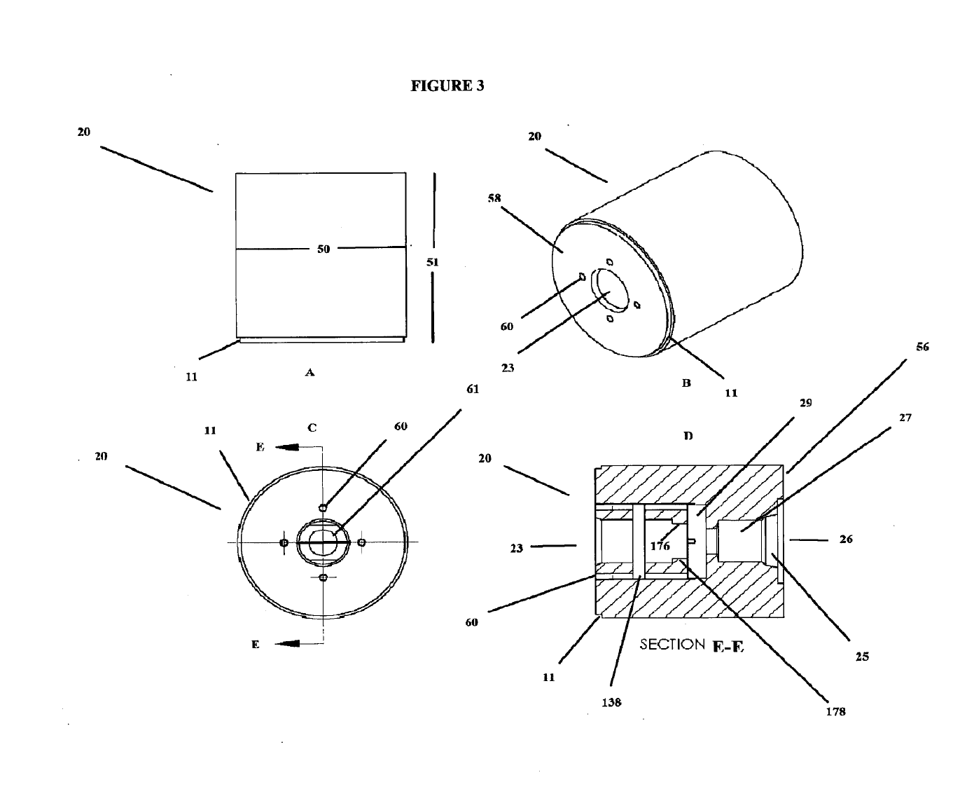

Referring to FIGS. 1, 2 and 3 the second body comprises a cylinder having a diameter 50 and a length 51. The bottom end 56 of the second body 20 is flat. Referring to FIG. 3D here is shown a cross section E-E of the second body 20. Within the bottom end 56 of the second body 20 is an aperture 26 which leads to a first cavity 25 which may contain suitable attachment means to attach the second hose 14 to the second body 20. Further into the second body 20 from aperture 26 is a second cavity 27 which may contain a non-return valve (not shown) to automatically cut fluid flow in case of a break in the second hose 14. Further within the second body is a third cavity 29 which functions as part of a back-pressure reduction apparatus more fully explained below. The top surface 58 of the second body 20 is also flat with an aperture 23 to receive portions of the first body 16 as more fully explained below. There are also apertures 60 which are to receive attachment screws 100 as more fully explained below. The top outside circumference 11 of the second body 20 is bevelled so as to accept dust ring 92.

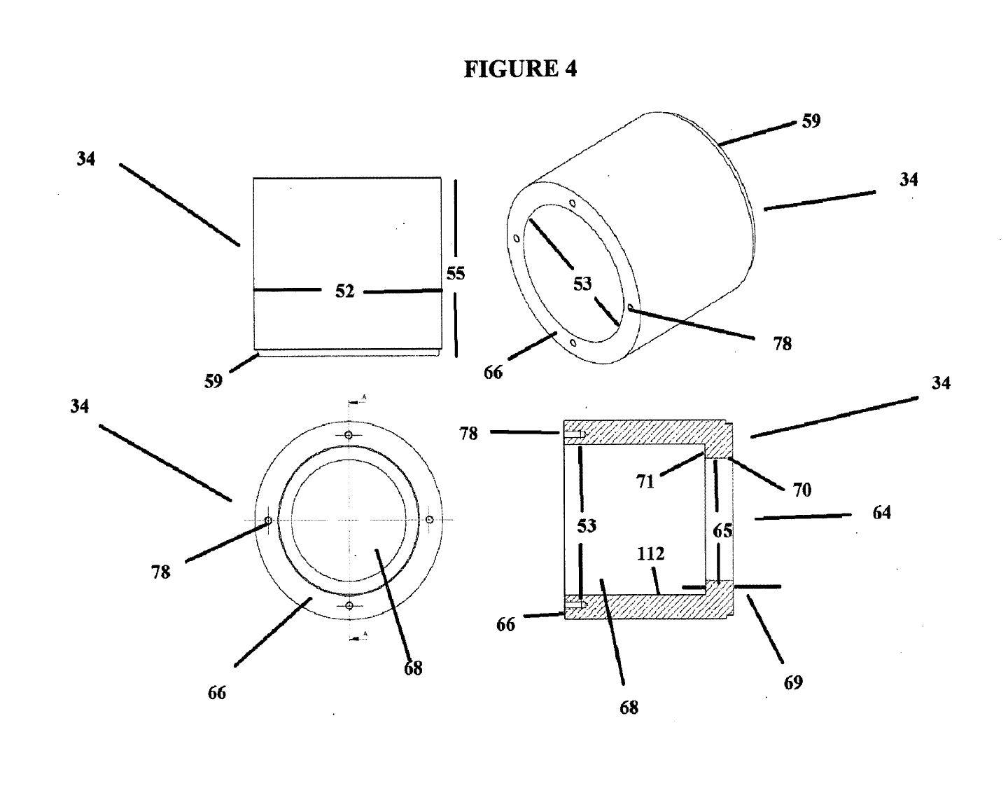

Referring now to FIGS. 1, 2 and 4 the fourth body 34 is illustrated. The fourth body 34 comprises a cylinder having a diameter 52 equal to that of the second 20 and first 16 bodies. The fourth body 34 has a height 55 and a flat top surface 66. The top surface 66 includes aperture 68 having an internal diameter 53 that is constant almost to the bottom surface 70 of the fourth body. The fourth body bottom surface has a thickness 69 and comprises a flat surface 70 having an aperture 64 having a diameter 65 to receive a portion of the first body 16 as more fully explained below. The bottom outer circumference 59 of the fourth body is bevelled to receive dust cover 92 as shown in FIG. 2. The flat top surface 66 has four apertures 78 to receive connecting screws 120.

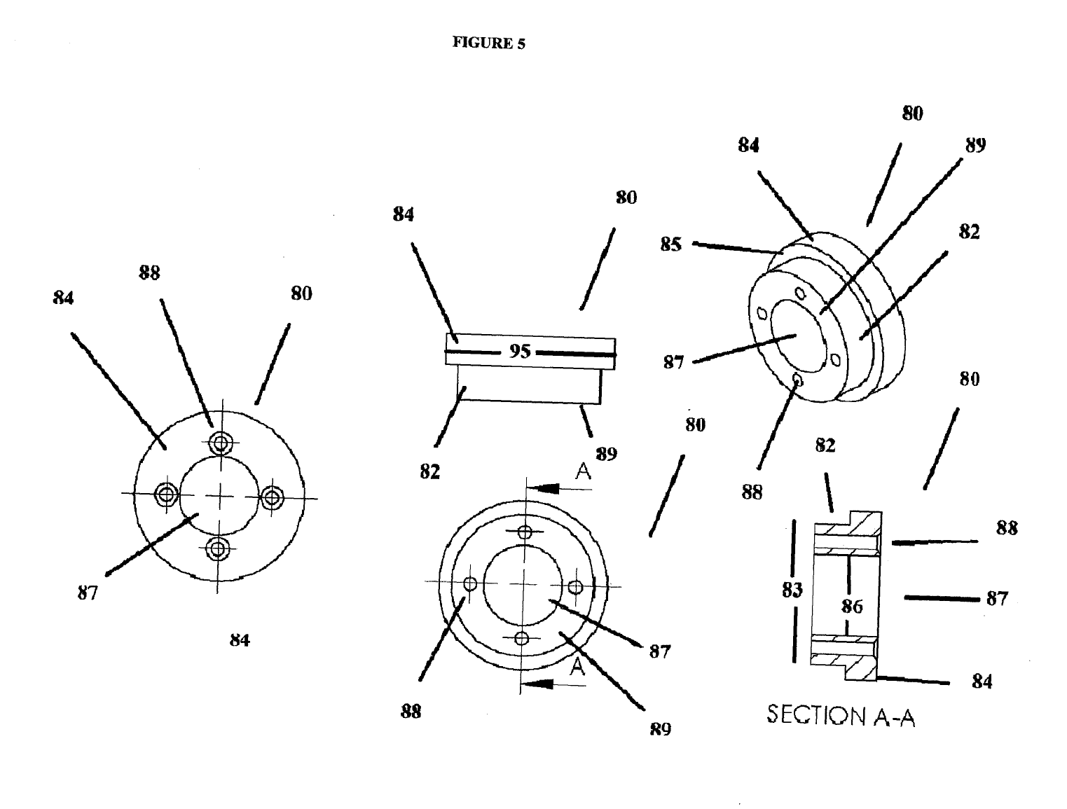

Referring now to FIGS. 1, 2 and 5 there are shown illustrations of the flanged coupling member 80. The flanged coupling member 80 couples the second body 20 to the fourth body 34 with dust ring 92 disposed between the two bodies. Once second body 20 is attached to fourth body 34 by the flanged coupling member 80, second body 20 is fixed within respect to the second hose member 14 while fourth body 34 is permitted clock-wise rotation around the flanged coupling member 80. The flanged coupling member 80 comprises an collar portion 82 and a flange portion 84 having a constant diameter 86 bore 87 from its top surface 84 to its bottom surface 89. The flanged coupling member 80 further includes four apertures 88 to receive fastening screws. The diameter 95 of the flange portion 84 slightly smaller than fourth body 34 top aperture 68 diameter 53 so that the flanged coupling member 80 can be placed inside of the fourth body. The diameter 83 of the collar portion 82 is slightly smaller than the diameter 65 of the bottom aperture 64 of fourth body 34 so that the collar can be fitted inside of aperture 64 and fourth body 64 can rotate around the collar portion 82. The flange portion 84 bottom surface 85 will contact inside surface 71 of the fourth body. Fastening screws 100 are then inserted into the apertures 88 of the flanged connecting member 80 and screwed into the apertures 60 of the second body thereby fixing the fourth body 34 to the second body 20 in a rotating relationship around the collar portion 82. First dust ring 92 is disposed between the second body 20 and the fourth body 34 and permits clock-wise rotation between them.

Referring to FIGS. 1, 2 and 6 there is illustrated third body 32 which comprises a sprag clutch portion 33 and coupling nut portion 92 fixed together so that they rotate together. The operation of a sprag clutch is well known and so further details regarding the sprag clutch are not necessary. The operation of the sprag clutch will prevent third body 32 from rotating counter-clockwise with respect to the fourth body 34 once it is placed within the fourth body. The outside surface 110 of the third body and the inside surface 112 of the fourth body comprise the elements of the sprag clutch so that relative rotation between these two bodies is permitted in the clock-wise direction only.

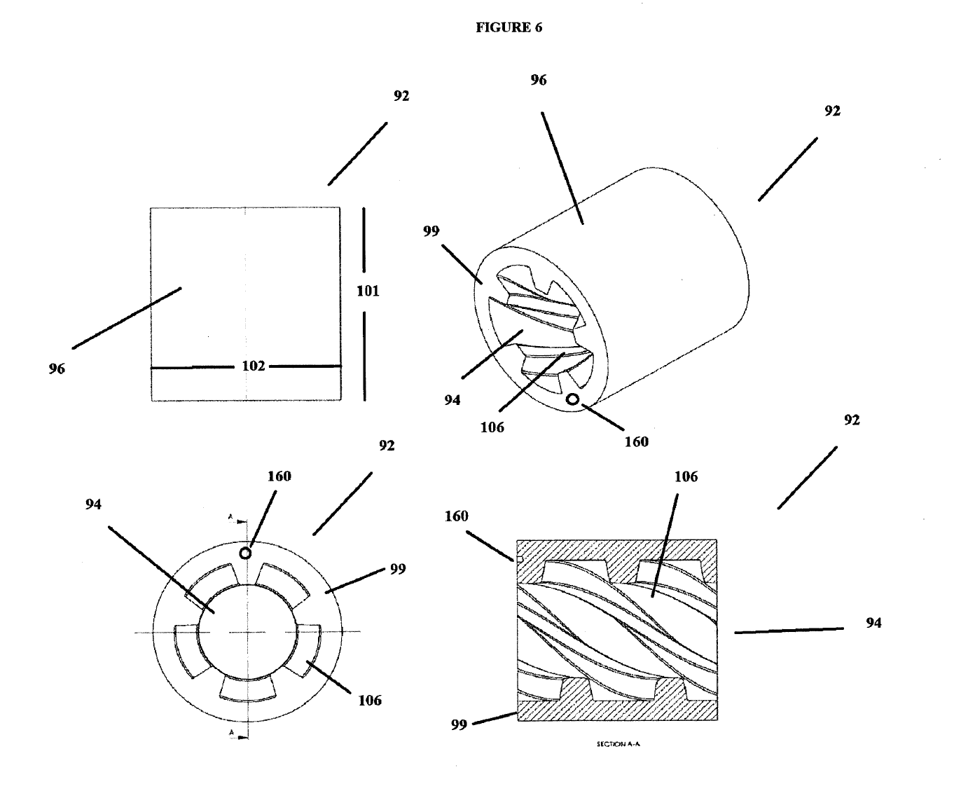

FIG. 6 shows detail of the coupling nut portion 92 of the third body 32. The coupling nut portion 92 has a height 101 and an outside diameter 102. The coupling nut portion 92 is apertured 94 having an internal thread pattern 106 matching the thread pattern 108 on threaded portion 30 of first body 16. The diameter 108 of the sprag clutch 33 portion of the third body 32 is smaller than the diameter of fourth body 34 top aperture 68 so that it fits inside of the fourth body. The outside surface of the third body 110 will act frictionally against the inside surface 112 of the fourth body 32 so that rotation is permitted only in the clock-wise direction.

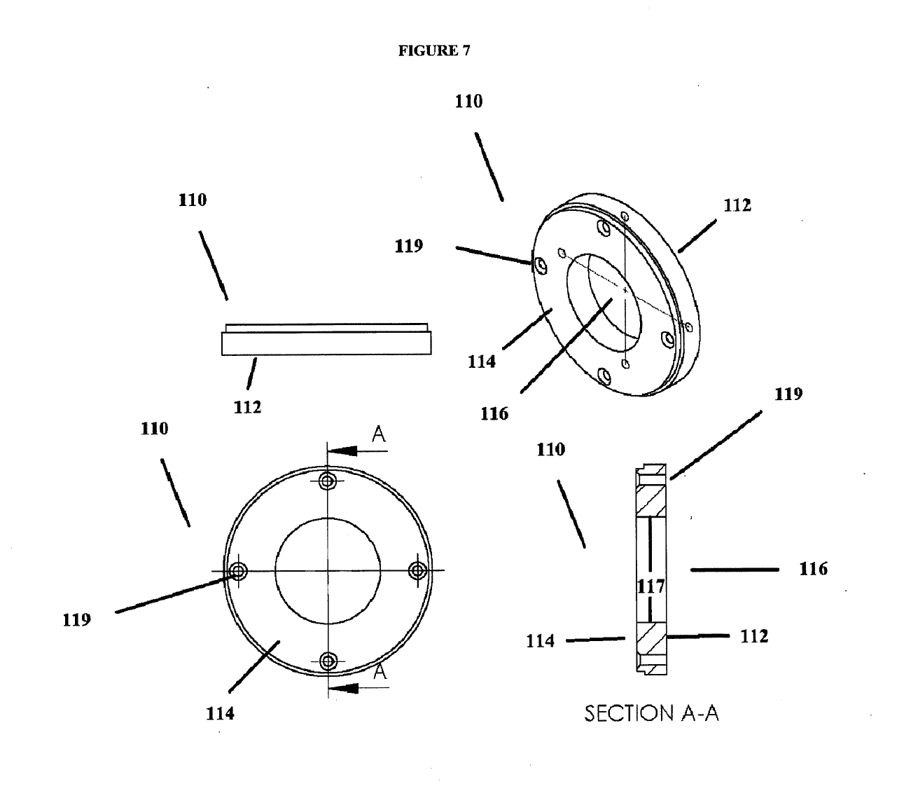

Referring now to FIGS. 1, 2 and 7 there is shown sealing plate 110 for sealing the third body 32 within the fourth body 34. The sealing plate 110 comprising a disk having a top surface 112, a bottom surface 114 and a bore 116 from the top surface to the bottom surface having a diameter 117 sufficiently wide to permit entry of the first body threaded portion 30. The sealing plate 110 further comprising at least four apertures 119 having alignment with the at least four apertures 78 on the top surface 62 of flange member 70 of the fourth body 34 so that the sealing plate 110 can be fixed to the top surface of the fourth body by screws 120.

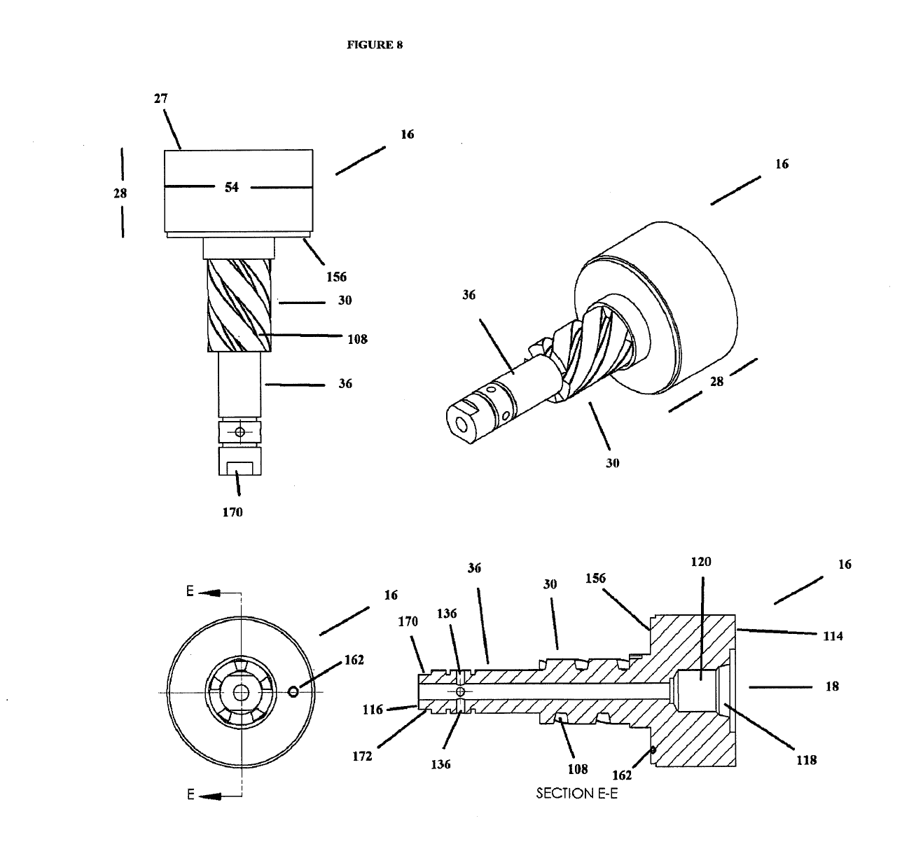

Referring now to FIGS. 1, 2 and 8 there is illustrated the first body 16. The first body 16 comprises a cylindrical head portion 27 having a height 28 and a diameter 54. As shown in cross-section FIG. 8D the first body 16 has a bore 18 from the top surface 114 to the bottom end 116. At the top end of the bore 18 there is a first cavity 118 for coupling means to attach the first hose member 12. A second cavity 120 may contain a non-return valve to shut off fluid flow in the event that there is a failure of the first hose.

FIG. 8 illustrates a head portion 27, a coupling portion 30 and a stem portion 36. The coupling portion 30 is threaded 108 to engage in a clock-wise twist with the threaded portion 92 of the third body thereby forming the coupling attachment between the first body and the third body. The threaded screw portion 30 is held within threaded nut portion 92 of the third body by torsion between the meshed threads. The threaded coupling is designed to resist a predetermined axial load between the first and third bodies. The threaded coupling will decouple only when axial loads exceed the torsional forces holding the threaded screw portion 30 within the threaded nut portion 92.

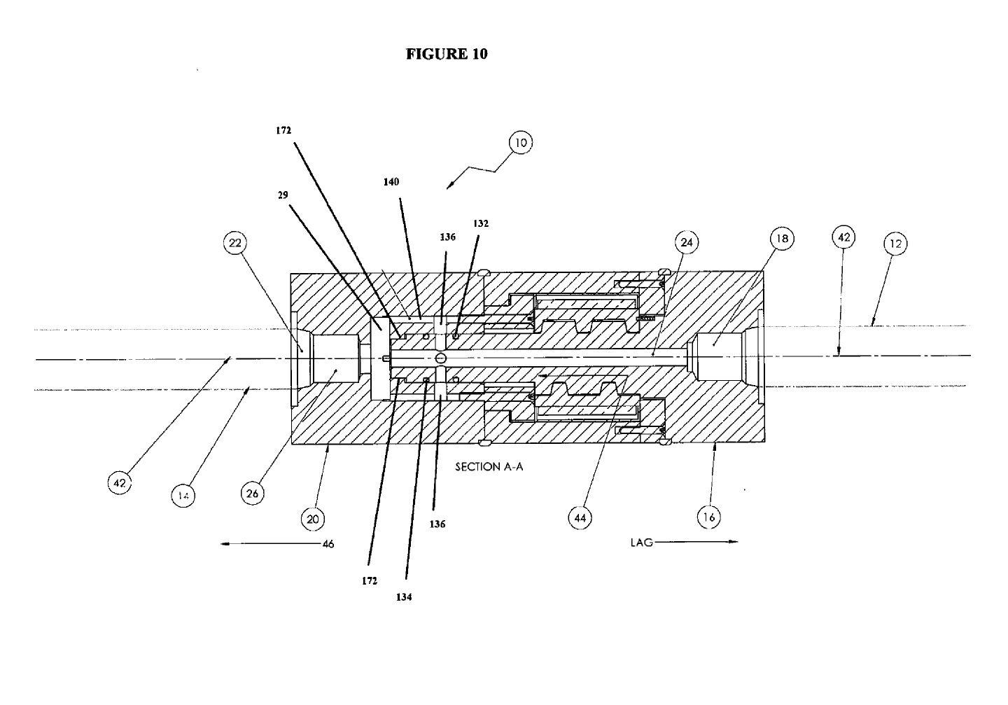

Referring to FIGS. 3, 8 and 10 the first body 16 further comprises a stem portion 36 projecting from the externally threaded coupling portion 30. The stem portion comprises a first sealing o-ring 130 and a second sealing o-ring 132 disposed on the outside surface 134 of the stem portion 36. Between the first and second sealing o-rings are at least four bores 138 equally spaced around the stem and in fluid communication with central bore 18. Referring to FIGS. 8 and 10, when coupling the first body 16 with the third body 32, the stem 36 is inserted into the second body 20 aperture 23 so that the bores 136 within the stem 36 are aligned with first by-pass chamber 138. Fluid entering the first body does not flow co-axially through the second body 20, rather, it is by-passed through a series of bores 136, channel 138 and ports 140 into chamber 29 and out of the second body into the second hose by way of aperture 26. The result of this configuration is the avoidance of fluid backpressures which may exert axial forces against the torsional forces holding the threaded screw to the threaded nut. The fluid forces are dissipated by inducing a lateral flow within the coupling. In FIG. 8, the bottom surface 116 has two flattened sides and two rounded sides due to a keyways 170 and 172 being formed in the bottom portion of the stem. These key ways mesh with keys 176 and 178 within the second body illustrated in cross-sectional diagram 3D of the second body and prevent the first body from rotating with respect to the second body. The stem is, in effect, locked in position within the second body once inserted. FIG. 10 shows in cross-section the relation between the keyways 172 and 174 and the keys 176 and 178 within the second body.

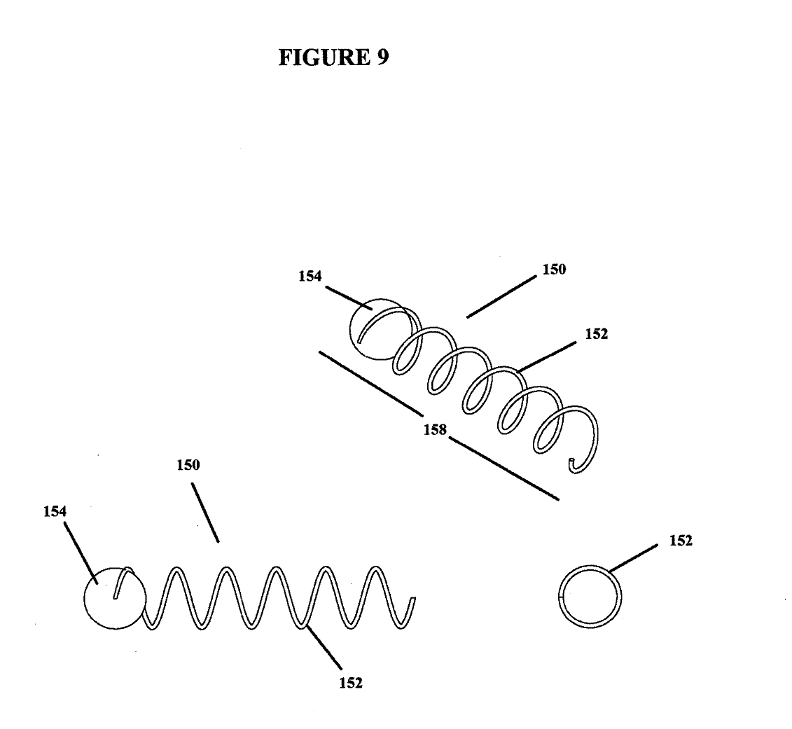

Referring to FIGS. 2, 6, 7, 9 and 10 the spring assembly 150 is shown and discussed. In FIG. 2, spring assembly 150 is shown protruding from the top surface 99 of the threaded nut portion 92 of the third body 32. The threaded nut portion 92 penetrates bore 117 within sealing plate 110 so that the top surface 99 of the threaded nut portion is proximate to the bottom surface 156 of the head portion 28 of first body 16. The distance between these two surfaces is slightly less than the length 158 of the spring assembly 150. The spring assembly 150 comprises a small spring 152 and a ball 154 held within the top of the spring. Referring to FIG. 6, the bottom of the spring 152 is placed within hole 160 so that the spring and ball protrude from the hole. The ball 154 is intended to sit within a small indentation 162 located on the bottom surface 156 of the head portion 27 of the first body 16. The contact between the threaded nut portion 92 and the first body 16 through the spring assembly 150 is able to dampen vibrations caused by fluid flow and provide a counter-torque to any vibration induced torques that might threaten to loosen the threaded coupling.

The coupling described herein constitutes a preferred embodiment of the invention however it is to be understood that the invention is not limited to the preferred embodiment disclosed. Other embodiments may be possible without departing from the scope and spirit of the invention as defined in the appended claims.

### MODE FOR INVENTION

### Industrial Applicability

Sequence List Text

1. A breakaway coupling for coupling a first hose member to a second hose member, wherein said first and second hose members carry a fluid, and wherein said breakaway coupling comprises a first body attached by first attachment means to the first hose member and a second body attached by second attachment means to the second hose member, and wherein said first body comprises a threaded portion for twist insertion into a threaded third body thereby forming a coupling adapted to resist a first predetermined decoupling axial force within said coupling, and wherein said threaded third body sealed within a fourth body, said fourth body fixed to the second body thereby coupling the first hose member to the second hose member and maintaining fluid communication between them.

2. The breakaway coupling of claim 1 wherein the first body further comprises a third stem portion depending from said threaded portion and integral thereto, wherein said third stem portion engages the second body in a locking relationship by a locking means to prevent rotation of the first body with respect to the second body.

3. The breakaway coupling as claimed in claim 2 wherein the first body stem portion further includes a first fluid backpressure dissipation means adapted to cooperate with a second fluid backpressure dissipation means within the second body thereby minimizing a second decoupling axial force due to axial movement of said fluid through the breakaway coupling.

4. The breakaway coupling of claim 3 wherein the first, second and fourth bodies are cylindrical and have the same outer diameter.

5. The breakaway coupling of claim 4 wherein the second body comprises a cylinder having a flat bottom surface, said second attachment means formed therein, a flat top surface, a bore extending into the second body from said flat top surface to communicate with the second attachment means, said bore adapted to receive said first body third portion in a tight fit, the flat top surface further comprising at least four apertures each adapted to receive a threaded screw.

6. The breakaway coupling of claim 5 wherein the fourth body comprises a hollow cylinder having a flat top surface having a top aperture and a flat bottom surface having a bottom aperture, a top flange member integral to said flat top surface and a bottom flange member integral to said flat bottom surface, wherein said top flange member includes at least four apertures each adapted to receive a threaded screw.

7. The breakaway coupling of claim 6 further comprising a flanged connecting member for connecting the fourth member to the second member, said flanged connecting member comprising an apertured collar having a diameter slightly smaller than the second body flat top surface bore so that said apertured collar fits tightly therein and an apertured flange integral to said collar said flange having a diameter larger than said fourth body bottom flange member so as to overlap the fourth body bottom flange member, the flange further comprising at least four apertures disk each adapted to receive a threaded screw.

8. The breakaway coupling of claim 7 wherein a sealing member is disposed between the second body and the fourth body, and wherein the flanged connecting member collar is placed within the second body flat top surface bore and the flange is disposed adjacent to the fourth body bottom member flange and so that the at least four apertures of the flanged connecting member align with the at least four apertures of the top flat surface of the second body and so that they may be screwed together.

9. The breakaway coupling of claim 8 wherein the third body is disposed within the fourth body and comprises a first hollow cylinder having a threaded interior surface and a smooth outer surface nested within a second hollow cylinder having a smooth inner surface and smooth outer surface, wherein said first hollow cylinder is permitted rotation within said second hollow cylinder and wherein the first hollow cylinder and said second hollow cylinder are permitted rotation within the fourth body.

10. The breakaway coupling of claim 9 further comprising a sealing plate for sealing the third body within the fourth body, said sealing plate comprising a disk having a top surface, a bottom surface and an aperture sufficiently wide to permit entry of the first body threaded portion, the sealing plate further comprising at least four apertures having alignment with said at least four apertures on the top surface flange member of the fourth body so that the sealing plate can be fixed to the top surface of the fourth body by screws.

11. The breakaway coupling of claim 10 wherein a second ring seal is disposed between the first body and the fourth body.
